(19) United States
(12) Patent Application Publication
(10) Pub. No.: US 2013/0311080 A1
(43) Pub. Date: Nov. 21, 2013

(54) Apparatus Configured to Select a Context Specific Positioning System

(71) Applicants: Lauri Wirola, Tampere (FI); Ville Myllylä, Tampere (FI)

(72) Inventors: Lauri Wirola, Tampere (FI); Ville Myllylä, Tampere (FI)

(73) Assignee: NOKIA CORPORATION, Espoo (FI)

(21) Appl. No.: 13/981,748

(22) PCT Filed: Feb. 3, 2011
(86) PCT No.: PCT/IB2011/050474

§ 371 Date: Jul. 25, 2013

(51) Int. Cl. G01C 21/30

(52) U.S. Cl. CPC G01C 21/30
USPC 701/409

(57) ABSTRACT

An apparatus comprising: a processor and memory including computer program code, the memory and the computer program code configured to, with the processor, cause the apparatus to: detect sound from an environment proximal to a device; determine a context of the device using the detected sound; and provide signaling to allow for selection of a context-specific service for use in navigation by the device based upon the result of the determined context.

### TECHNICAL FIELD

The present disclosure relates to the field of context-specific services, associated methods and apparatus, and in particular concerns the use of audio signals in the selection of context-specific services. Certain disclosed example aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Location-based services require at least two types of information. The first of these is location information, which may be obtained using various positioning technologies, including satellite navigation (GPS, GLONAS, Galileo, QZSS, or SBAS), a mobile phone network, Wi-Fi, radio frequency identification, Bluetooth™, and near field communication, to name but a few. The second type of information is content associated with the current geographical location. Such content may be location-based advertisements or a navigable map, for example.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided an apparatus comprising:
a processor and memory including computer program code, the memory and the computer program code configured to, with the processor, cause the apparatus to:
detect sound from an environment proximal to a device;
determine a context of the device using the detected sound; and
provide signaling to allow for selection of a context-specific service for use in navigation by the device based upon the result of the determined context.

The term “navigation” may be taken to encompass both the determination and monitoring of geographical location, and may therefore be used interchangeably with the term “positioning”.

The context may be whether the device is located indoors or outdoors. The context-specific service may be a geographical positioning service and/or a map.

When the device is determined to be located outdoors, the geographical positioning service may be a satellite navigation service. When the device is determined to be located indoors, the geographical positioning service may be one or more of the following: a mobile phone network service, a wireless local area network service, a radio frequency identification service, a Bluetooth™ service, and a near field communication service. This feature may help to decrease power consumption by allowing navigation circuitry and/or hardware which is not required at that moment in time to be switched off (e.g. the GPS circuitry and/or receiver when a mobile phone network is being used for positioning).

When the device is determined to be located indoors, the map may be a floor plan. When the device is determined to be located outdoors, the map may be a street map.

The context may be a motion state of the device. The motion state may be the mode of transport being used to transport the device. The mode of transport may be one or more of the following: on foot, by road vehicle, by train, by boat, and by plane. The expression “on foot” may be taken to encompass walking, jogging and running. Also, the expression “by road vehicle” may be taken to encompass motorised (e.g. cars, vans, lorries, motorbikes etc) and non-motorised (e.g. bicycles etc) vehicles.

The context-specific service may be a map and/or a motion model associated with the determined mode of transport. When the mode of transport is determined to be on foot, the map may be a pedestrian map. When the mode of transport is determined to be by road vehicle, the map may be a road map. Likewise, when the mode of transport is determined to be by train, boat or plane, other types of map suitable for use with these transport methods may be selected. The motion model may be one or more of a constant acceleration, constant velocity, and constant location model.

Determination of the device context may be performed by comparing the detected sound with one or more prerecorded sounds stored in a database. Determination of the device context may be performed by comparing one or more audio features extracted from the detected sound with one or more respective predetermined audio features stored in a database.

Comparison of the one or more audio features extracted from the detected sound with one or more respective predetermined audio features may be performed using a classification method. The classification method may comprise one or more of the following: K-nearest neighbours, hidden Markov modelling, dynamic time warping, and vector quantization.

The one or more audio features may comprise one or more of the following: power spectra, zero crossing rate, short-time average energy, mel-frequency cepstral coefficients, mel-frequency delta cepstral coefficients, band energy, spectral centroid, bandwidth, spectral roll-off, spectral flux, linear prediction coefficients, and linear prediction cepstral coefficients.

The prerecorded sounds and/or the predetermined audio features may be stored in the database according to time and/or location.

The detected sound may be sound emitted by one or more sources external to the device, and/or the echo of a test sound emitted by the device. Determination of the device context using the echo of a test sound may be performed by analyzing one or more characteristics of the echo.

The sound emitted by one or more sources external to the device may be used to determine the device context only if it has a power level above a predetermined threshold. This feature relates specifically to sound emitted from sources external to the device (i.e. passive determination) rather than test sounds emitted from the device itself (i.e. active determination).

Determination of the device context may be performed at the device. Determination of the device context may be performed at a location remote to the device. Determination of the device context may be performed at a database server located remote to the device.

Selection of the context-specific service may be performed automatically by the device. The selection may be performed automatically only when a single context-specific service is available for selection. Selection of the context-specific service may be performed manually by a user of the device. The selection may be performed manually only when there are two or more context-specific services available for selection.

The apparatus may comprise an acoustic transducer. The sound from the environment proximal to the device may be detected by the acoustic transducer. The acoustic transducer may be a microphone.

The apparatus may be one or more of the following: an electronic device, a portable electronic device, a portable telecommunications device, a navigation device, and a module for any of the aforementioned devices.

According to a further aspect, there is provided a database server, the database server configured to:
receive audio data associated with sound detected from an environment proximal to a device;
determine a context of the device using the received audio data; and
send the result of the determined context to allow for selection of a context-specific service for use in navigation by the device.

The audio data may comprise an audio signal and/or one or more audio features associated with the detected sound.

According to a further aspect, there is provided a method, the method comprising:
detecting sound from an environment proximal to a device;
determining a context of the device using the detected sound; and
providing signaling to allow for selection of a context-specific service for use in navigation by the device based upon the result of the determined context.

One or more of these steps may only be performed when a user of the device has enabled and/or activated navigational functionality on the device.

The steps of any method disclosed herein do not have to be performed in the exact order disclosed, unless explicitly stated or understood by the skilled person.

According to a further aspect, there is provided a non-transitory computer-readable memory medium storing a computer program, the computer program comprising computer code configured to perform any method described herein.

The apparatus may comprise a processor configured to process the code of the computer program. The processor may be a microprocessor, including an Application Specific Integrated Circuit (ASIC). The processor may be a processor dedicated to the processing of audio data.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 shows one method of determining the context of a device;

FIG. 2 shows measured power spectra for different audio environments;

FIG. 3a shows a street map associated with the device location;

FIG. 3b shows a floor plan associated with the device location;

FIG. 4 shows a plurality of possible motion states;

FIG. 5a shows a street map associated with the device location and motion state;

FIG. 5b shows a street map associated with the device location and a different motion state;

FIG. 6 shows a device comprising the apparatus described herein;

FIG. 7 shows a database server configured to interact with the device of FIG. 6;

FIG. 8 shows the key steps of the method described herein; and

FIG. 9 shows a computer readable medium providing a program for carrying out the method of FIG. 8.

### DESCRIPTION OF SPECIFIC ASPECTS/EMBODIMENTS

One of the key goals of future navigation systems is to provide seamless indoor-outdoor navigation. In order to achieve this, however, such systems must be able to determine whether they are currently located indoors or outdoors. This may be considered as “context determination”. Context determination is important because indoor navigation methods are typically unsuitable for outdoor use, and vice versa. For example, whilst GPS is the preferred system for car navigation, it is unsuitable for indoor navigation due to signal attenuation, refraction and reflection issues. Similarly, whilst wireless local area networks (WLANs) may be used for indoor positioning, their use is limited to within the ranges of the wireless access points. Context determination is also important because the maps required for each type of navigation are different: outdoor navigation typically requiring the use of a street map, and indoor navigation typically requiring the use of a floor plan. It would therefore be advantageous for future navigation systems to enable selection of a navigation method and map corresponding to the current device context.

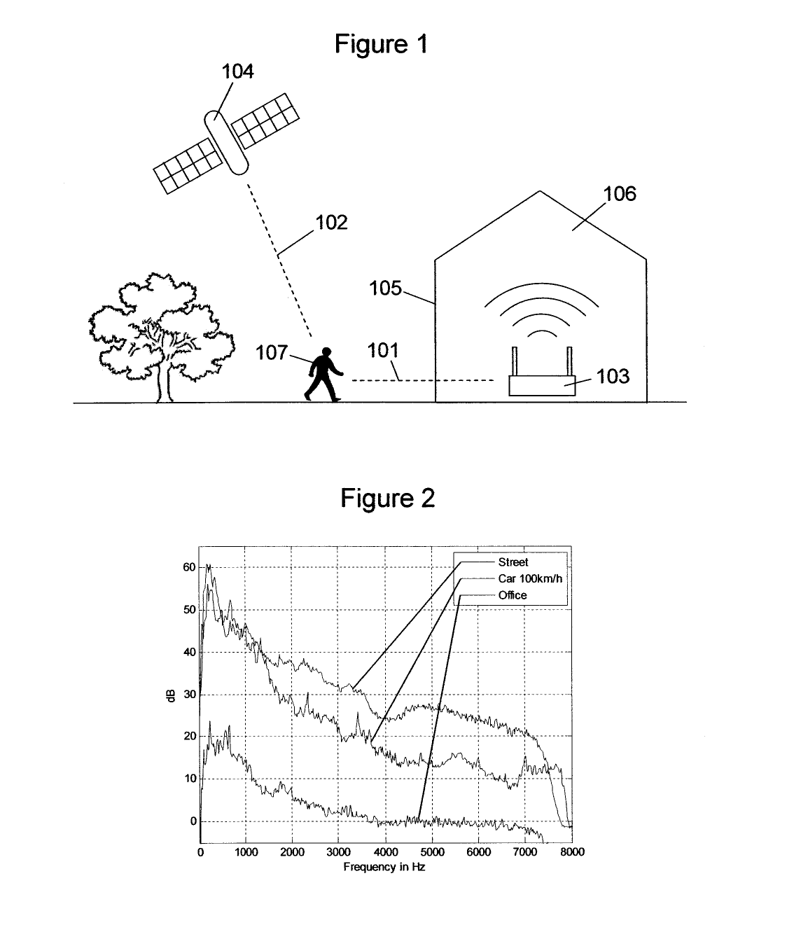

Context determination is not a trivial task, however. One approach, as illustrated in FIG. 1, is to use the detection of signals 101, 102 from indoor or outdoor positioning technologies (e.g. WLAN 103 or GPS 104) as an indication of whether the device is located indoors or outdoors, respectively. A problem with this technique, however, is that the signal 101, 102 from each positioning technology 103, 104 often extends beyond the indoor-outdoor boundary 105. Therefore, whilst the detection of a WLAN 103 might indicate the proximity of a building 106, it does not necessarily mean that the device is located inside the building 106. For example, a user 107 of the device might simply be passing by a building 106 within which a WLAN 103 is located. In this scenario, it would be undesirable for the device to switch from the use of GPS 104 and a street map to WLAN 103 and a floor plan of the building 106 on detection of the WLAN 103.

There will now be described an apparatus and associated methods which may or may not address this issue.

The present apparatus detects sound from an environment proximal to a device in order to determine a context of that device. As discussed previously, a key context to determine is whether the device is located indoors or outdoors. The audio environment provides an alternative method of distinguishing one location from another, and may be used either together with or instead of existing methods (such as the detection of signals from indoor or outdoor positioning technologies, as described with respect to FIG. 1).

Determination of the device context may be performed by comparing the detected sound with one or more prerecorded sounds (e.g. audio signals) stored in a database to determine a match. For example, the prerecorded sounds may include the sound associated with walking on different surfaces, e.g. the sound of ice crunching underfoot vs the sound of walking on a carpeted floor. Another example might be the sound of street traffic vs the sound of a typical office environment. In fact, any sounds which enable the device to distinguish between the indoors and outdoors could be stored in the database.

Given the vast number of potential prerecorded sounds and the finite size of the database, however, the prerecorded sounds may be stored in the database according to time and/or location. In one embodiment, the database may be configured to store a set of prerecorded sounds for a particular time of day, and then replace this set of sounds with another set of sounds as the day progresses. In this way, only the most relevant sounds (i.e. those which are most likely to be used in determining the device context) are stored at any given time. For example, the sound of the dawn chorus may be useful first thing in the morning, but will probably not be as useful in the middle of the afternoon. In this respect, there may be little point in maintaining the sound of the dawn chorus in the database after dawn.

For larger databases and/or more powerful processors, it may not be necessary to update the database as frequently as this. For example, it might be sufficient to update the database on a daily basis (e.g. given that the audio environment on weekdays is usually different to the audio environment at the weekend), or on a seasonal basis (e.g. given that the sound of walking on ice in winter is usually different to the sound of walking on leaves in autumn). Additionally, or alternatively, the database could be updated based upon the geographical location of the device (e.g. given that the audio environment of an urban location is usually different to the audio environment of a rural location). Updating the database in this way may help to reduce the database memory, processing time and processing power required to determine the device context. Another way of reducing the processing time and power is to compare only detected sounds which have a power level above a predetermined threshold with the prerecorded sounds. This approach may help to restrict the signal processing to sounds which originated closest to the device location, and which are therefore a more accurate representation of the environment proximal to the device.

Instead of, or as well as, comparing the detected sound with one or more prerecorded sounds stored in a database, the apparatus may extract one or more audio features from the detected sound (using various known signal processing techniques), and compare the extracted audio features with one or more predetermined audio features stored in a database. For example, the extracted audio features may be power spectra or mel-frequency cepstral coefficients. Comparison of the extracted audio features with the predetermined audio features may be performed using a number of different classification methods, such as K-nearest neighbours, hidden Markov modelling, dynamic time warping, and vector quantization. FIG. 2 shows measured power spectra for three different audio environments: an office, a car, and a street. As can be seen from this graph, the office and street have rather distinct power spectra, and would therefore be useful for differentiating one context from the other. By using audio features rather than full audio signals, less storage space may be required in the database. Furthermore, the bandwidth needed for transmitting the audio data from one device to another may reduced. This is advantageous if the audio data is to be sent between the device and a database server for context determination (discussed later).

Active methods may also be used to determine the device context, and may supplement or replace the previously described passive methods. For example, in the event that all sounds from external sources have a power level below the predetermined threshold (and the apparatus is being operated in the power-saving mode described above), test sounds may be used for context determination instead (regardless of their power level). In this scenario, the apparatus may switch from passive determination to active determination after a predetermined period of time. This avoids the need to wait for detectable environmental sounds, and thereby serves to reduce power consumption associated with prolonged monitoring of the audio environment.

One approach involves the emission of a test sound from the device, and subsequent analysis of the echo characteristics (i.e. analysing the impulse response of the environment). The test sound may be emitted at a frequency inside or outside (above or below) the human audio range, and may comprise a low power pulse (e.g. at sufficiently low power to be nonintrusive or even inaudible). The use of a low power pulse may help to minimise power consumption. For example, given that the reverberation time usually differs strongly between indoors and outdoors, a measurement of the reverberation time may be used to determine whether the device is located indoors or outdoors. A measurement of the echo's intensity, or the time taken to receive the first reflected sound could also be used. For greater accuracy, a combination of any of the above-mentioned techniques (active or passive) could be used to determine the device context.

Once the device context has been determined, the apparatus allows for selection of a context-specific service for use by the device based upon the result of the determined context. Selection of the context-specific service may be performed automatically by the device, or manually by a user of the device. For example, if there is only one available service corresponding to the determined device context (such as GPS), the device may access or activate that service without any input from the user. On the other hand, if there are one or more available services corresponding to the determined device context (such as GPS and a WLAN), the device may prompt the user to access or activate a service manually (e.g. from a list of possible options). One particular scenario is when a user is located at an indoor/outdoor boundary and there are context-specific services available for both indoor and outdoor use. In this situation, the device may present the user with both the indoor and outdoor options and allow the user to select the context-specific service (and therefore effectively determine the device context) himself/herself.

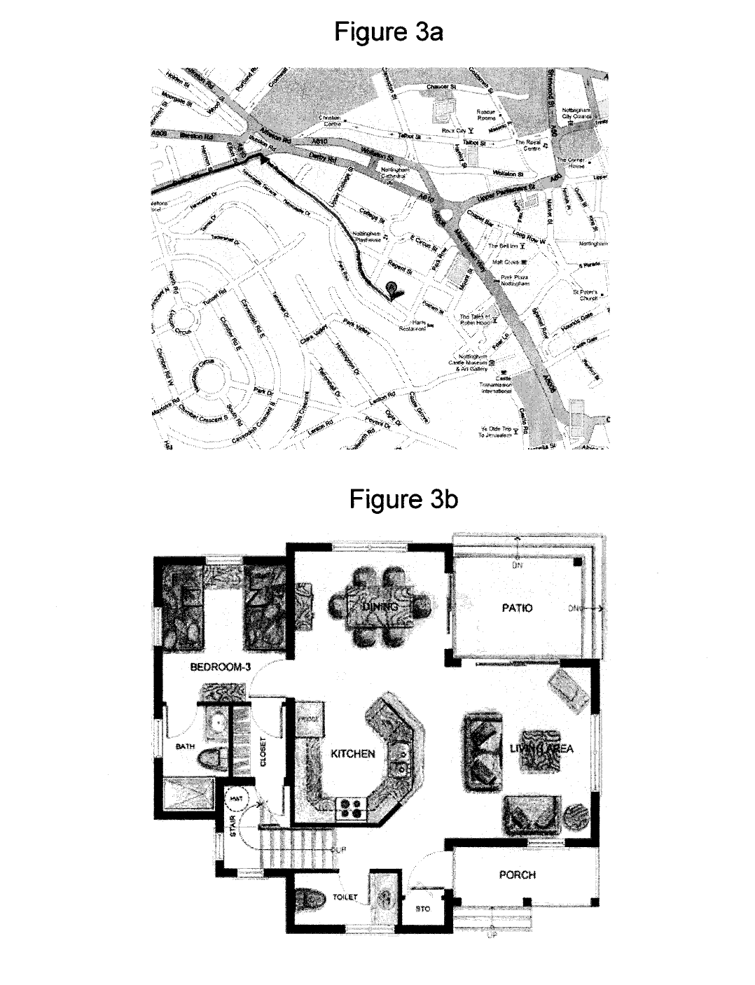

With respect to navigation systems, the context-specific service may be a geographical positioning service and/or a map. Therefore, if the apparatus determines that the device is located outdoors, it may provide signalling to allow for selection of a satellite navigation service and/or street map (illustrated in FIG. 3a) associated with the current device location. On the other hand, if the apparatus determines that the device is located indoors, it may provide signalling to allow for selection of an in-range WLAN and/or floor plan (illustrated in FIG. 3b) associated with the current device location. The floor plan may, for example, be the floor plan of a shopping centre or airport at which the device is currently located. It should be noted, however, that a number of different technologies may be used for indoor positioning aside from a WLAN, any of which may be made available for selection based on the determined context. Specific examples include a mobile phone network, radio frequency identification, Bluetooth™, and near field communication services.

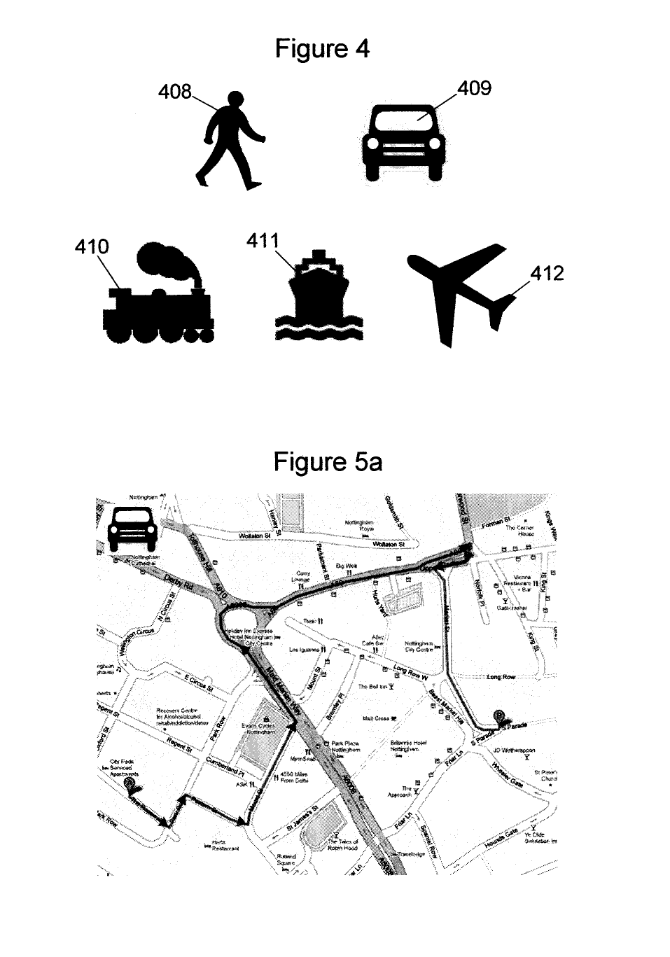

Another device context which may be determined using the detected audio signal is the motion state of the device. The motion state may be considered to be the current mode of transport being used to move the device from one place to another. For example, as illustrated in FIG. 4, the mode of transport may include movement on foot 408, by road vehicle 409, by train 410, by boat 411, or by plane 412. The motion state can be determined using the detected audio signal because each mode of transport has an associated set of distinctive sounds. For example, the sound of footsteps is markedly different from the sound of a car's engine, and the sound of a train on a railway line is markedly different from the sound of waves breaking on the hull of a ship.

Determination of the motion state is important for navigation systems which provide multiple navigation modes (such as car navigation and pedestrian navigation), because it affects the underlying motion model in the positioning algorithm. This is because the movement characteristics of each motion state are different: pedestrian movement may be characterised using a “random walk” trajectory, whilst the movement of a car is more constrained in terms of speed, acceleration and direction. The motion model is used to filter the position data as well as predict the future motion and location of the device in order to increase the navigation accuracy and/or smooth the trajectory.

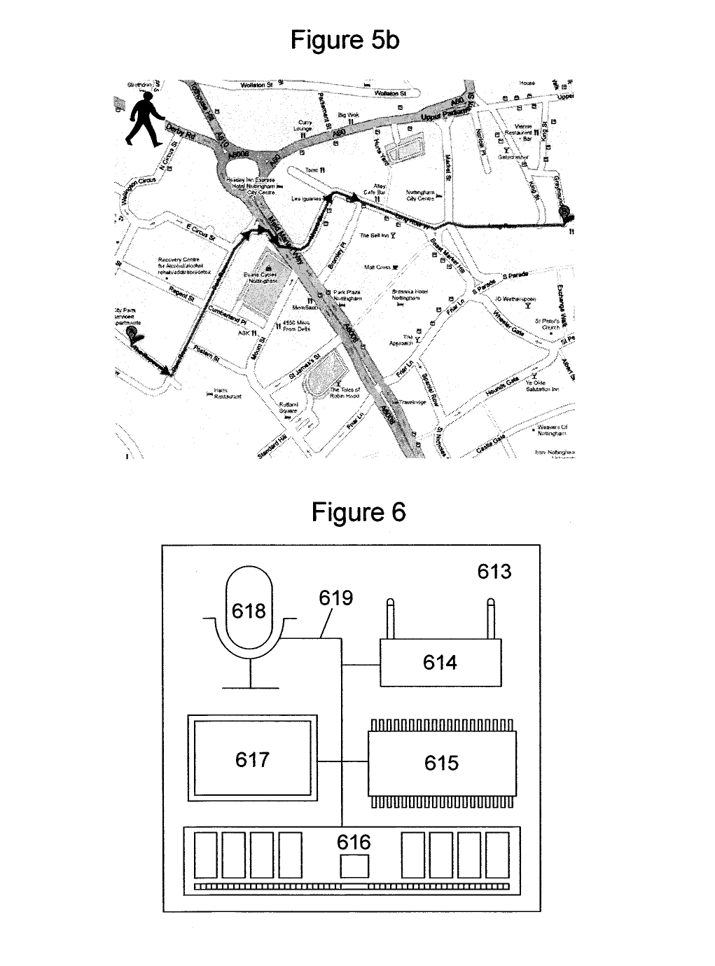

The motion state of the device also affects the nature and content of the map which is presented to the user. For example, whilst cars are confined to roads, and are forced to conform to the laws governing road use, pedestrians have a greater freedom of movement. In this respect, a pedestrian wanting to know the fastest route from one location (A) to another location (B) will be more interested in a map detailing pedestrian pathways (as shown in FIG. 5b) than a map providing the fastest route by car (as shown in FIG. 5a). The pedestrian map may, for example, be a map of a university or research campus. By determining the motion state, the device is able to allow selection of a navigation mode (motion model and/or map) based upon the determined motion state.

Determination of the device context may take place at the device itself, but could be performed at a location remote to the device (e.g. at a database server located remote to the device). In this respect, the apparatus necessary to carry out the method described herein may form part of the device and/or the database server. Regardless of where the context determination takes place, however, the detection of sound from the proximal environment will always be performed at the device.

FIG. 6 illustrates schematically a device 613 configured to perform the method described herein. The device 613 comprises a transceiver 614, a processor 615, a storage medium 616, a display 617, and a microphone 618, which may be electrically connected to one another by a data bus 619. The device 613 may be an electronic device, a portable electronic device, a portable telecommunications device, a navigation device, or a module for any of the aforementioned devices.

The microphone 618 is configured to detect sound from the environment proximal to the device 613, and convert the sound to an electrical audio signal for subsequent analysis. In some embodiments, the device 613 may also comprise a loudspeaker (not shown) configured to emit test sounds for active context determination.

The processor 615 is configured to receive the electrical audio signal, determine the device context, and provide signalling to allow for selection of a context-specific service. The processor 615 may be a central processor (e.g. digital signal processor) configured for general operation of the device 613 by providing signalling to, and receiving signalling from, the other device components to manage their operation. On the other hand, the processor 615 may be a separate processor dedicated to the processing of audio signals. Unlike a central processor, a dedicated processor may use a separate audio channel (e.g. active noise cancellation channel) for the transfer of audio signals. An advantage of this configuration is that only hardware necessary for carrying out the method described herein needs to be activated (i.e. the apparatus may be operated in a power saving mode). In contrast, the use of a central processor would typically require activation of the whole device 613. When audio features are being used to determine the device context, the processor may also be configured to extract said audio features from the audio signal.

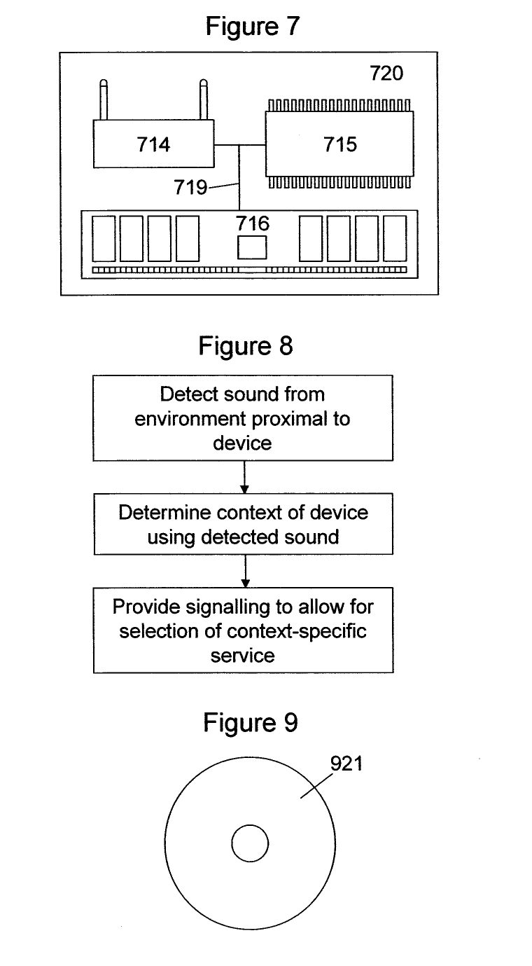

As discussed previously, determination of the device context may be performed by comparing the detected sound/electrical audio signal with one or more prerecorded sounds/electrical audio signals stored in a database, or by comparing one or more extracted audio features with one or more predetermined audio features stored in a database. The database itself may be stored in the storage medium 616, or may be stored in a database server (FIG. 7) external to the device 613.

The storage medium 616 is configured to store computer code configured to perform, control or enable operation of the device 613, as described with reference to FIG. 9. In addition, the storage medium 616 may be configured to store settings for the other device components. In this scenario, the processor 615 may access the storage medium 616 to retrieve the component settings in order to manage operation of the other device components. The storage medium 616 may be a temporary storage medium such as a volatile random access memory. On the other hand, the storage medium 616 may be a permanent storage medium such as a hard disk drive, a flash memory, or a non-volatile random access memory.

The transceiver 614 is configured to enable determination of the device location, and may be configured for communication with GNSS satellites, a mobile phone network, a WLAN, a radio frequency identification enabled device, a Bluetooth™ enabled device, or a near field communication enabled device. The transceiver 614 may also be configured to transmit audio signals/data from the device 613 to a database server for determination of the device context, and to receive the result of the determined context from the database server for use in selecting a context specific service.

The display 617 is configured to present one or more context-specific services to the user of the device 613 for selection and/or use. For example, when multiple context-specific services are available for use, a list of the available services may be presented to the user for manual selection. The context-specific services may include a geographical positioning service, a map, and/or a motion model. Maps similar to those shown in FIGS. 3 and 5 may be shown on the display 617 for navigation purposes.

FIG. 7 shows a database server 720 configured for interaction with the device 613 of FIG. 6. As described previously, determination of the device 613 context may be performed by the database server 720 rather than the device 613 itself. The use of a database server 720 may be particularly advantageous when the capacity of the device storage medium 616 is too small to store the database of prerecorded sounds and/or predetermined audio features, or when the processing power of the device 613 is insufficient to enable determination of the device context in a reasonable time. The use of a database server 720 may also help to reduce power consumption of the device 613.

The database server 720 comprises a processor 715, a storage medium 716 and a transceiver 714, which may be electrically connected to one another by a data bus 719. The transceiver 714 is configured to receive audio signals/data from the remote device 613, the audio signals/data associated with sound detected from an environment proximal to the device 613. The storage medium 716 contains a database of prerecorded sounds and/or predetermined audio features for determination of the device context, and the processor 715 is configured to determine the device context by comparing the received audio signal and/or extracted audio features with entries stored in the database. Once the device context has been determined, the transceiver 714 sends the result to the device 613 for use in selecting a context-specific service.

The main steps of the method described herein are illustrated schematically in FIG. 8.

FIG. 9 illustrates schematically a non-transitory computer/processor readable memory medium 921 providing a computer program according to one embodiment. In this example, the computer/processor readable medium 921 is a disc such as a digital versatile disc (DVD) or a compact disc (CD). In other embodiments, the computer/processor readable medium 921 may be any medium that has been programmed in such a way as to carry out an inventive function. The computer/processor readable medium 921 may be a removable memory device such as a memory stick or memory card (SD, mini SD or micro SD).

The computer program may comprise computer code configured to perform, control or enable one or more of the following: the detection of sound from an environment proximal to a device; the determination of a context of the device using the detected sound; and the provision of signaling to allow for selection of a context-specific service for use in navigation by the device based upon the result of the determined context.

When the detected sound is the echo of a test sound emitted by the device (i.e. active context determination), the computer program may also comprise computer code configured to perform, control or enable emission of the test sound.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor,

Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-36. (canceled)

37. An apparatus comprising:
a processor and memory including computer program code, the memory and the computer program code configured to, with the processor, cause the apparatus to:
detect sound from an environment proximal to a device;
determine a context of the device using the detected sound; and
provide signaling to allow for selection of a context-specific service for use in navigation by the device based upon the result of the determined context.

38. The apparatus of claim 37, wherein the context is whether the device is located indoors or outdoors.

39. The apparatus of claim 38, wherein the context-specific service is at least one of: a geographical positioning service and a map.

40. The apparatus of claim 39, wherein, if the device is determined to be located indoors, the geographical positioning service is at least one of the following: a mobile phone network service, a wireless local area network service, a radio frequency identification service, a Bluetooth™ service, and a near field communication service and the map is a floor plan.

41. The apparatus of claim 37 wherein determination of the device context is performed by at least one of the following:
a) comparing the detected sound with at least one prerecorded sound stored in a database, and
b) comparing at least one audio feature extracted from the detected sound with at least one respective predetermined audio feature stored in a database.

42. The apparatus of claim 41, wherein comparison of the at least one audio feature extracted from the detected sound with at least one respective predetermined audio feature is performed using a classification method.

43. The apparatus of claim 42, wherein the classification method comprises at least one of the following: K-nearest neighbours, hidden Markov modeling, dynamic time warping, and vector quantization.

44. The apparatus of claim 41 wherein the at least one audio feature comprises at least one of the following: power spectra, zero crossing rate, short-time average energy, mel-frequency cepstral coefficients, mel-frequency delta cepstral coefficients, band energy, spectral centroid, bandwidth, spectral roll-off, spectral flux, linear prediction coefficients, and linear prediction cepstral coefficients.

45. The apparatus of claim 41, wherein at least one of the prerecorded sounds and the predetermined audio features are stored in the database according to at least one of time and location.

46. The apparatus of claim 37 wherein determination of the device context is performed at at least one of the device and a location remote to the device.

47. The apparatus of claim 37 wherein determination of the device context is performed at a database server located remote to the device.

48. The apparatus of claim 37 wherein determination of the device context using a echo of a test sound is performed by analyzing at least one characteristic of the echo.

49. The apparatus of claim 37, wherein the selection of the context-specific service is performed automatically by the device.

50. The apparatus of claim 49, wherein the selection is performed automatically only when a single context-specific service is available for selection.

51. A method, the method comprising:
detecting sound from an environment proximal to a device;
determining a context of the device using the detected sound; and
providing signaling to allow for selection of a context-specific service for use in navigation by the device based upon the result of the determined context.

52. A method, the method of claim 51 further comprising:
determining from the detected sound if the context is indoors or outdoors.

53. A method, the method of claim 52 further comprising:
determining from the context the navigation service to be selected for use.

54. A method, the method of claim 52 further comprising:
the determination of the device context is performed at a database server located remote to the device.

55. A non-transitory computer-readable memory medium storing a computer program, the computer program comprising computer code configured to perform the method of claim 53.

56. A database server, the database server configured to:
receive audio data associated with sound detected from an environment proximal to a device;
determine a context of the device using the received audio data; and
send the result of the determined context to allow for selection of a context-specific service for use in navigation by the device.

57. The database server of claim 56, wherein the audio data comprises at least one of an audio signal and an audio feature associated with the detected sound.
